(19) United States
(12) Patent Application Publication
(10) Pub. No.: US 2010/0129635 A1
(43) Pub. Date: May 27, 2010

(54) FACED INSULATION AND METHOD OF MAKING SAME

(75) Inventors: Elizabeth Mae Drzyzga, Midland, MI (US); Allen Ross, Midland, MI (US); Matthew Jay Hansen, Midland, MI (US); Robert Lee McGee, Midland, MI (US)

Correspondence Address: THE DOW CHEMICAL COMPANY / DOBRUSIN & THENNISCH PC, 29 LAWRENCE STREET, STE. 210, PONTIAC, MI, 48342, US

(73) Assignee: Dow Global Technologies Inc.

(21) Appl. No.: 12/595,352

(22) PCT Filed: Apr. 25, 2008
(86) PCT No.: PCT/US08/61563

§ 371 Date: Oct. 9, 2009

Related U.S. Application Data
(60) Provisional application No. 60/917,746, filed on May 14, 2007.

(51) Int. Cl. B32B 5/02; B32B 38/10

(52) U.S. Cl. 428/292.1; 156/269

(57) ABSTRACT

The present invention is an improved product (and process for making the same) that includes as a single integrated structure an insulation layer (particularly a layer that includes insulation made from a polymeric synthetic material) and a facer layer that helps function to resist moisture and retard vapor. An optional bond interface layer including at least one adhesive joins the facer layer with the insulation layer.

### CLAIM OF PRIORITY

The present application claims the benefit of the filing date of U.S. Provisional Application No. 60/917,746 (filed 14 May 2007), the contents of which are hereby incorporated by reference in their entirety.

### FIELD OF THE INVENTION

The invention relates to polymeric fibrous insulation, and more specifically to polymeric fibrous insulation that has a facing for improving moisture, and vapor retardation for use in residential and commercial building structures.

### BACKGROUND

In recent years, building material manufacturers have made advancements toward improving insulation properties of material for use in constructing building enclosures (e.g. walls). Consumer and regulatory demands have also imposed a need for improved weather and moisture barrier properties. Historically, efforts to satisfy the need for insulation, as well as weather and moisture barriers, have been addressed by use of house wraps and insulation, each supplied and installed independent of each other. Fiberglass and mineral wool insulation using kraft paper, alone or in combination with a barrier layer such as, for example, aluminum foils are known. Faced polymeric fiber insulation batts are also known. However, for example in U.S. Pat. No. 5,723,209 to Hoechst, one facing material is permeable. It would be desirable to provide a facing for a polymeric insulation batt that generally retards vapor and does not adversely impact the appearance or performance of the insulation batt.

### SUMMARY OF THE INVENTION

The present invention meets the above need by providing an improved product that includes as a single integrated structure an insulation layer, particularly a layer that includes insulation made from a polymeric synthetic material, and a facer layer, particularly one adapted for resisting moisture, retarding vapor or both. More specifically, the invention meets the need by providing a faced polymeric fibrous polymer insulation batt wherein the facer comprises a barrier film and an optional bond interface layer that includes at least one adhesive, and a process for laminating the facer to the batt. The fibrous insulation batt has a density of from about 5 to 25 kg/m³ and has a lambda (thermal conductivity) below about 45 mW/m-K (measured per EN ISO 8301-91 at 10° C.), preferably, below about 40 mW/m-K, still more preferably below about 35 mW/m-K. The fibrous insulation batt includes or may even consist essentially of an entangled mass of polymeric fibers that are characterized by an average fiber diameter from about 5 microns to about 40 microns, more preferably from about 8 microns to about 30 microns still more preferably from about 10 to about 20 microns. Faced fiber batt structures according to the present teachings are useful in a number of applications, and are particularly attractive for thermal and/or acoustic insulation in residential or commercial building applications where there is also a need for vapor retardation, moisture exclusion, or both.

Accordingly, pursuant to one aspect of the present invention, there is contemplated a faced fiber insulation batt that may include at least one facer layer and a fiber insulation layer, the facer layer being joined with the fiber insulation layer via at least one bond interface layer that includes at least one adhesive.

The invention may be further characterized by one or any combination of the features described herein, such as the facer layer may include at least one layer with a melting temperature, as measured by DSC, of greater than 125° C.; the facer layer may include at least one material chosen from the group consisting of polypropylene, high density polyethylene, blends of polypropylene with polyolefin, blends of high density polyethylene olefins, and any combination thereof; the at least one adhesive may be a single layer adhesive film located on at least one side of the facer layer; the at least one adhesive includes one or more materials selected from the group consisting of anhydride modified polyethylene or anhydride modified copolymers of polyethylene, ethylene-acrylic acid, ethylene-vinyl acetate, ethylene methyl acrylate, ethylene-methacrylic acid polymer, blends of the former with low density polyethylene and linear low density polyethylene, and any combination thereof; the thickness of the bond interface layer may range from 1 to 25 microns, and further wherein the bond interface layer may include an adhesive with a melt flow index that ranges from 1 to 5; the facer layer may include at least a top layer and a bottom layer, wherein the top layer melting point may be greater than 30° C. and a thickness of 15 to 200 microns; the faced fiber insulation batt may have a critical radiant heat flux, as determined by ASTM E-970, of equal to or greater than 0.12 W/cm2; the faced fiber insulation batt may have a density greater than 5 kg/m3; the faced fiber insulation batt may have a lambda value less than 50 mW/m-K; the fiber insulation layer may include a plurality of polymeric fibers with an average diameter from 3 to 50 microns, and a fiber melting temperature above 70° C.; the fiber insulation layer may include at least 55% by weight of a staple fiber and at least 15% by weight of a bicomponenet fiber; at least one surface of the facer layer may have a surface energy above 40 dyne/cm; the at least one adhesive of the bond interface layer may have a melting temperature at least 5° C. above the fiber batt polymeric fiber melting temperature; the at least one adhesive may exhibit a melt flow index of greater than 1.5; the facer layer may include a single layered film of a material selected from the group consisting of Polypropylene, High Density Polyethylene, blends of Polypropylene with Polyolefin, blends of High Density Polyethylene olefins, and any combination thereof.

Accordingly, pursuant to another aspect of the present invention, there is contemplated the use of the faced fiber insulation batt according to of the above described invention.

Accordingly, pursuant to another aspect of the present invention, there is contemplated a method for producing a faced fiber insulation batt, that may include the steps of feeding a fiber batt having a first thickness onto a moving conveyor; applying heat to the fiber batt and to a facer film; joining the facer film to at least the top side of the fiber batt while applying a compressive load to the batt and the facer film sufficient to realize a compressive ratio of the fiber batt from the first thickness to a final thickness that ranges from 25:1 to 2:1; conveying the facer film and fiber batt to a cooling area; cooling the facer film and the fiber batt; and cutting the faced fiber batt to a pre-set length.

The inventive method may be further characterized by one or any combination of the features described herein, such as the temperature during the applying heat step (B) may be at least 60° C.; the velocity of the moving conveyor may be at least 1 m/min; the compressive load may be applied over a contact length of at least 3 cm; the step of cutting may be performed by a barrel rotary cutter that spins along an axis generally perpendicular to the direction of motion of the conveyor, and wherein the barrel rotary cutter may include at least one set of cutting blades disposed generally perpendicular to and in a direction away from the surface of an external surface of the barrel rotary cutter; the step of heating may include applying heat by convection of heated air; the temperature of the heated air may be at least 150° C.; the step of heating may be done by conduction via contact with at least one heated surface zone; the temperature of the at least one heated surface zone may be at least 80° C.; the at least one heated zone may be at least 25 mm in length, and may span in a direction generally parallel to conveyor; an adhesive may be applied to form a bond interface layer between the facer film and the fiber batt.

Accordingly, pursuant to another aspect of the present invention, there is contemplated a faced fiber insulation batt that may be prepared according to the above stated method.

Accordingly, pursuant to another aspect of the present invention, there is contemplated the use of the faced fiber insulation batt that may be prepared according to the above stated method.

### DESCRIPTION OF THE DRAWINGS

FIG. 1 is a schematic view of a faced insulation structure

FIG. 2 illustrative view of a hot air lamination machine.

### DETAILED DESCRIPTION OF THE PREFERRED EMBODIMENT

The invention herein is predicated upon a unique combination of features and processing steps for achieving the same. In accordance with one aspect of the invention, there is disclosed a faced polymer fibrous insulation structure that includes a facer layer, and a fibrous polymeric insulation layer. In a particular aspect of the invention, the facer comprises a film (e.g., a barrier film) which adjoins the fibrous insulation layer, in direct contact therewith, in contact via a bonding interface layer (e.g., one or more adhesive or adhesion layers), or both. For example, one preferred approach is to bond the facer layer and the insulation layer together using pressure, heat, an adhesive, or any combination thereof.

One preferred approach is to employ as the insulation layer a fibrous insulation batt that has a density of from about 5 to about 25 kg/m³, more specifically about 5 to about 15 kg/m³ and still more preferably form about 6 to 14 kg/m³. Though not required in each instance, one attractive polymeric fibrous insulation batt will further exhibit a lambda value (determined according to EN ISO 8301-91 at 10° C.) of below about 45 mW/m-K, more preferably, below about 42 mW/m-K, still more preferably below about 38 mW/m-K and yet still more preferably below about 35 mW/m-K. The fibers that are characterized by an average fiber diameter from about 5 microns to about 40 microns, more preferably from about 8 microns to about 30 microns and still more preferably from about 10 to about 20 microns. For purposes of this invention, average diameter is determined according to the relation:

$$AverageDiameter = \frac{\sum \frac{{x}_{n}}{{D}_{n} * {d}_{n}}}{\sum \frac{{x}_{n}}{{D}_{n}^{2} * {d}_{n}}}$$

where xₙ represents the weight fraction of fiber n, Dₙ represents the diameter of fiber n and dₙ is the density of fiber n. This average diameter represents a weight average diameter.

Though other techniques may be used to bond the facer layer to the polymer batt, an adhesive bonding system desirably is used, by which at least one adhesive is brought into contact with each of the facer layer and the insulation layer (e.g., over at least a portion of the opposing faces of each) for causing the facer layer and the insulation layer to become joined together, via a bonding interface layer (namely, a layer that includes the at least one adhesive). Any of a number of suitable approaches toward application of adhesive may be employed. In a preferred approach, however, the adhesion is achieved by use of a film that includes or consists essentially of an adhesive; the adhesion is achieved by application of an adhesive. More particularly, the film-based adhesive system can either be manufactured as part of the facer layer or brought in as a separate component during the mating of the facer layer and polymeric fibrous insulation batt. Preferably, the adhesive film is manufactured together with the facer layer. This facer layer/adhesive assembly is then laminated to the polymeric fibrous insulation batt.

Adhesive films or webs may be employed in which the adhesive side of the film is surface treated or untreated prior to application of the adhesive. A common method of surface treatment is corona treatment in which an electrical discharge causes ionization of airborne oxygen, which in turn will contact the surface of the plastic film causing oxygen-containing functional groups to form on the film surface. This oxidation causes the film surface to become more polar and have a higher surface energy; thereby potentially increasing lamination adhesion.

In one preferred embodiment, the bonding interface layer includes a hot-melt adhesive which bonds the insulation layer to the facer layer upon application of heat, and optionally the application of a suitable pressure; a pressure sensitive adhesive that bonds the insulation layer to the facer layer upon application of pressure, and optionally the application of a suitable temperature, or both. It is desired, in one aspect that the bonding interface layer be processed for bonding the facer layer to the insulation layer under conditions that generally avoid the infiltration of the interface layer to the insulation layer for forming a skin of the interface layer on the insulation layer. For example, in one specific embodiment, the insulation layer comprises an entangled mass of polymeric fibers, a portion (15% to 45%) of which are binder fibers. The binder fibers are preferably bi-component binder fibers, in that they are made up of at least two sections of polymer. The exterior section is characterized by having a lower softening temperature. “Softening temperature” in this context, means a temperature at which a fiber (or portion thereof) becomes soft enough as to become tacky and capable of adhering to another fiber in the polymeric fibrous insulation batt. Such a section constitutes at least a portion of the surface of the bi-component fiber. At least one other section is of a higher-softening material, which softens at a somewhat higher temperature, which allows the lower-softening material to be softened during the heat-setting process without softening the higher-softening portion of the fiber. Typically the melting or softening point of the binder fiber or lower melting layer of the bicomponent binding fiber is at least 10° C. below that of the other fibers comprising the fibrous insulation batt.

Desirably, the layers are processed below a maximum lamination temperature that would correspond generally with the softening temperature of the bonding component of the bicomponent fibers in the polymer fiber batt. Depending on the exact lamination procedure (dwell time in the heated zone) and the thickness of the facer layer, temperatures as much as about 10-15° C. above said fiber-bonding temperatures might be acceptable. Common binding fibers are bicomponent polyester fibers with a binding temperature of about 110° C.

The minimum lamination temperature for achieving a tenacious bond with the bond interface layer generally will also be high enough so that the adhesive of the bond interface layer does not cause further binding to the batt when the faced product is rolled or compressed for shipment. Thus, ordinarily, it is desired that the adhesive of the bond interface layer will not excessively soften or become tacky at storage and transport temperatures to which it is expected to be subjected. This effect is comparable to finding the lowest temperature that will laminate the film in an experiment during which the lamination dwell time is very long (days or weeks) compared to the dwell time found during industrial laminations (typically a few seconds).

Thus, the lamination temperature is above about 60° C., and preferably above about 70° C., as tested in an experiment in which the lamination dwell time is about 1 second. Polar copolymers of polyolefins are adhesive in nature and are among the candidate polymers for use in the at least one adhesive of the bond interface layer. Preferred polar polyolefin polymers are those whose melting properties yield lamination temperatures within the above stated range. Useful compositions of the adhesive layer include, but are not limited to anhydride modified polyethylene or anhydride modified copolymers of polyethylene ethylene-acrylic acid, ethylene-vinyl acetate, ethylene methyl acrylate, ethylene-methacrylic acid polymer of various commoner contents and blends or mixtures of these materials with themselves or other polymers, for example low density polyethylene, linear low density polyethylene and the like, such that the blended materials have the appropriate lamination temperature.

The thickness and melt flow index of the bond interface layer are generally selected so that a sufficient amount of polymeric constituents from the adhesive layer of the film can flow and intermingle with the insulation layer, and particularly with the fibers of the batt, to form the bond between the facer and the insulation layer. The bond interface layer thickness can range from about 2.5 microns to about 30.0 microns or more. If the adhesive layer is too thin an inadequate bond is formed. It is preferred that the adhesive layer be at least 2.5 microns, more preferably at least 5 microns and still more preferably at least 7.5 microns in thickness. If the bond interface layer is too thick, it is believed that it becomes more difficult to limit the penetration of adhesive into the fibers of the batt, which if not managed, is believed to potentially lead to the formation of a fibrous skin layer bonded by the adhesive rather than the binding fibers. It is desirable that the bond interface layer is as thin as is required to produce a successful lamination. Thus it is preferred that the bonding interface layer be less than about 25 microns, more preferably less than about 18 microns, still more preferably less than about 15 microns in thickness. For this invention, the adhesive of the bond interface layer with have a melt index, measured by ASTM D1238, preferably greater than about 2, and more preferably greater than about 2.5.

In one possible embodiment, a discrete bond interface layer may be omitted. For instance, it may be possible to employ as the facer layer a suitable film that functions to bond itself suitably to the insulation layer. By way of example, it may be possible to employ a film (e.g., a co-extruded film) that includes a plurality of layers, at least one of which includes a relatively low melting point polymer thereon, which is capable of bonding at a temperature below the melting point of the batt. The facer layer can thus be heated beyond the melting temperature of the lower film layer, preferably from about 5° C. to about 20° C. beyond, and brought into contact with the fiber batt. In its softened or molten state, the low melting point layer of the film layer is capable of flowing and intermingling with the fibers of the batt, or otherwise bonding with the batt. It is preferred that the facer layer should have a composition and thickness such that it does not wrinkle during the lamination step, and so that the faced insulation batt meets the requirements for moisture permeability. The facer layer may comprise a single layer (e.g., layer A) or a plurality of adjoining layers (e.g., layer A plus layer B plus layer C), such as may be achievable by coextruding a film. Desirably, the facer layer is also sufficiently fire retardant that it would satisfy the requirements of ASTM E-84, as well as any resulting article into which the facer layer is incorporated. At a minimum, the resulting combination of the facer layer in conjunction with the batt would satisfy the requirements of ASTM E-84.

In instances in which the facer layer includes a multiple layer structure, it is desired that the outermost layer (e.g., the layer furthest from the bonding interface layer), will have a peak melting point (according to ASTM D5857) that is at least about 30° C. above the highest temperature employed during the process of manufacturing the articles herein. For example, the outermost layer will have a peak melting point that ranges from about 30° C. to 110° C., more specifically about 40° C. to about 90° C., still more specifically about 50° C. to about 70° C. above the highest lamination temperatures employed in the manufacturing processes herein. Among the more preferred polymers for use in films for the facer layer are polyolefin films, and specifically polypropylene, a copolymer including propylene, polyethylene (e.g., high density polyethylene), a copolymer including ethylene, one or more blends of polypropylene with a polyolefin of density less than about 0.92 g/cc (Olefin block copolymers are exemplary of this group), and blends of high density polyethylene with other olefins wherein the blends have the requisite melting point and lamination behavior. Additionally, the polymer film could also be selected from films of polystyrene polymers and copolymers, polyolefins, polyamides, polyesters, polycarbonates, polyurethanes, polyacrylates, polyvinyl alcohol, polyethylene vinyl alcohol), poly(alkylene vinyl acetates), poly(alkylene acrylates), ionomers, and mixtures thereof. A preferred facer layer includes a polypropylene blend, and a more preferred facer layer consists essentially of Polypropylene. An example of a commercially available material for this use is INTEGRAL™ D200 from The Dow Chemical Company

Other noteworthy properties, all per ASTM D 882, of the facer layer may include, one or more of but are not limited to: Ultimate Tensile Strength ranging from about 10 N/mm² to about 35 N/mm², preferably from about 20 N/mm² to about 30 N/mm²; Tensile Modulus, 2% Secant ranging from about 120 N/mm² to about 350 N/mm², preferably from about 250 N/mm² to about 300 N/mm²; and Ultimate Elongation ranging from about 100 to about 700 percent, preferably from about 400 to about 575 percent; or any combination of the foregoing.

The thickness of the facer layer desirably is relatively thin. Film thicknesses typically range from about 15 microns to about 200 microns or more. As stated, it is preferable to have total film thickness as low as possible; this is not to say a thicker facer layer may not be appropriate in certain applications. Preferred film thickness ranges are from about 100 microns to about 25 microns, more preferably about 75 microns to about 37 microns, and still more preferably less than about 65 microns or even less than about 50 microns.

The insulation material of the insulation layer includes or may even consist essentially of a synthetic organic polymeric material. More specifically, the insulation layer is a mass of entangled and bonded polymeric fibers. Preferably, the insulation material desirably includes a material prepared in accordance with the teachings of commonly owned pending U.S. Provisional Patent Application Ser. No. 60/795,464 (filed 27 Apr. 2006) and PCT Application No. PCT/US07/10232 (filed 26 Apr. 2007), both entitled “Polymeric fiber insulation batts for residential and commercial construction applications”, and both being hereby incorporated by reference.

Accordingly, in general the insulation layer will include or consist essentially of a compressible polymeric fiber thermal insulation batt formed of entangled and melt-bonded polymeric fibers, the polymeric fibers including from 55-85% by weight of at least one staple fiber, and from 15-45% by weight of at least one binder fiber. The staple fibers are characterized in having a length (at full extension, if crimped) of from about 25 mm to about 300 mm, preferably from about 25 mm to about 150 mm, and especially from 30 to 75 mm. The staple fibers may be hollow or solid. They may have a circular cross-section or more complex cross-sectional shape (such as elliptical, multi-lobed and the like). The average fiber diameter is from 5 to 40 microns, preferably from 8 to 30 and still more preferably from 10.0 to 20.5 microns and at least 55% by weight of the fibers are crimped. The insulation material thus A) has an uncompressed bulk density of from 5 to 25 kg/m³, B) exhibits a lambda value (measured per EN ISO 8301-91 at 10° C.) of from 30-50 mW/m-K.

The insulation may be provided in the form of a boardstock having an uncompressed thickness of from about 25 to 300 mm.

In another aspect, the insulation layer may include or consist essentially of a rolled polymeric fiber thermal insulation batt, the batt having an uncompressed thickness of from about 25 to 300 mm, and an uncompressed bulk density of from about 5 to 15 kg/m³. The batt may be compressed in the roll to about 25% or less of its uncompressed thickness, wherein the polymeric batt is formed of entangled and melt-bonded polymeric fibers. Upon unrolling and re-expansion, the material preferably exhibits a lambda value of from about 30-50 mW/m-K.

The above-described insulation batt may be made according to the teachings of U.S. Provisional Patent Application Ser. No. 60/795,464 (filed 27 Apr. 2006) and PCT Application No. PCT/US07/10232 (filed 26 Apr. 2007), and thus may include steps of forming a web of entangled polymeric fibers by pneumatic carding, calibrating and heat-setting the web to form an insulation batt containing entangled and heat-bonded polymeric fibers. At least about 55% by weight of the fibers are crimped. It is also possible to include one or more steps of forming a stack of said multiple web sections; and calibrating and heat-setting the stack of web sections to form an insulation batt containing multiple individual plies of entangled and heat-bonded polymeric fibers, each individual ply having a thickness of from about 0.36 to 10.0 mm.

The invention herein also contemplates methods of making the above-described articles, and particularly a method for making a faced insulation roll or batt by which the facer layer is joined with the insulation layer (optionally in the presence of a bonding interface layer) by lamination under application of pressure, elevated temperature, or both application of pressure and elevated temperature.

As indicated previously, the lamination temperature is selected so as to avoid undesired visible wrinkles or melting defects in the facer layer, and is sufficiently low so that uncontrolled melting of polymeric constituents (e.g., fibers) within the insulation layer is generally avoided, by which, upon re-solidification, the material of the insulation layer would form a skin on the surface to be joined with the facer layer. The temperature of the lamination step is also sufficiently high to achieve the desired performance of any adhesive of the bonding interface layer. By way of example, the lamination temperature will be at least about 60° C., more specifically at least about 70° C., still more specifically at least about 80° C. The lamination temperature is about 115° C. or below, preferably about 110° C. or below, more preferably about 100° C. or below and still more preferably about 95° C. or below to prevent defects like wrinkles or a compacted skin layer on the fibrous polymeric insulation batt. (Temperatures as measured using the 2-roll lamination procedure described below in Examples 1-3.)

The lamination pressure/batt compression ratio must be low enough so that the combination of lamination pressure and temperature does not result in failure of the batt to reloft, after being compressed during the lamination step, The compression ratio can be as high as about 25:1, but is preferably about 15:1, and is more preferably about 10:1 and is most preferably less than about 4:1. The lamination pressure must not be so great that wrinkles can form in the facer surface. However, the lamination pressure is preferably greater than zero to achieve a well-bonded attractive facer and batt appearance. An example of suitable pressures applied is from about 0.0 to about 1.5 N/mm².

Articles herein may be prepared in a batch or continuous mode. One approach is to feed separate webs of each of the facer layer, any bonding interface layer, and the insulation layer between at least two opposing rollers, at least one of which is heated. A preferred approach is to feed a web consisting essentially of a multi-layer facer adhesive film and a second layer consisting essentially of the insulation layer. Upon exiting the rollers a laminated assembly is realized, in which the insulation layer is bonded to the facer layer thus providing a faced insulation structure. Lamination equipment generally consists of a conveying system for moving an article to be laminated through a series of application stations whereby the lamination material is applied to the article, conveyance speeds can range from 0.1 m/min. to as high as 100 m/min. Generally, heat is applied to the article or the lamination material either before the respective items are joined or contemporaneously with the joining; typical temperatures range from room temperature to in excess of 150° C. Additionally, the lamination process typically employs pressure to aid in the joining of the article and the lamination material. This is typically accomplished by a pinch roller or a movable plate that compresses the article and lamination material. Typical pressure ranges from about 0 to about 5 N/mm².

With reference to FIG. 2, one illustrative process includes a conveyor for moving the article, an air blown heating system to heat the article, an application station to join the article and lamination material and a roller system to apply pressure to the joined materials to aid in the joining process.

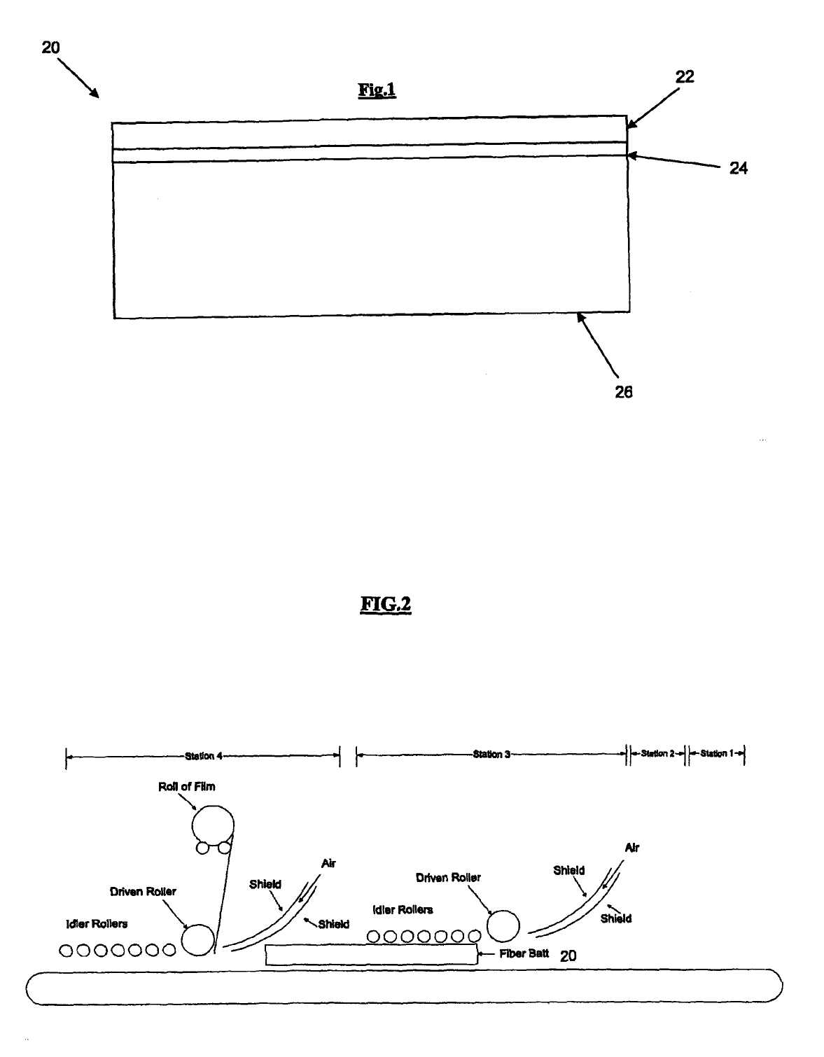

The resulting article is shown in FIG. 1, and shows a faced fiber batt insulation article 20, including a facer layer 22, a bonding interface layer 24, and an insulation layer 26. It will be appreciated that the insulation layer may be faced on two or more of its sides following the teachings herein. For example, the insulation layer may be sandwiched between opposing bonding interfaces, between opposing facer layers, or both. As to the latter, it is possible that the materials of the opposing facer layers may be the same as, or may differ relative to one another.

In addition to the layers described, additional layers may be added for other functionality, for example a metallized layer for improved insulation performance or an adhesive layer to aid in lamination of the batt to another component, or a decorative layer. For example, the facer layer may be colored or printed in order to provide a decorative appearance.

Other embodiments of the invention will be apparent to those skilled in the art from a consideration of this specification or practice of the invention disclosed herein. It is intended that the specification and following examples be considered as exemplary only, with the true scope and spirit of the invention being indicated by the claims herein. Unless otherwise stated, properties recited in the claims are determined according to the test methods described in this specification.

### EXAMPLES

The following illustrates how a person skilled in the art can effectively determine suitable lamination temperatures, lamination pressure, and other parameters and processing characteristics for achieving desired resulting characteristics.

### Example 1

A polyester fiber batt is provided, being prepared according to U.S. Provisional Patent Application Ser. No. 60/795,464 (filed 27 Apr. 2006) and PCT Application No. PCT/US07/10232 (filed 26 Apr. 2007). The composition of the batt is about 70% polyester staple fiber and about 30% bicomponent fiber in which both the core and sheath portion are polyester. The melting point of the low melting sheath portion of the bicomponent fiber is about 110° C. The batt being prepared according to the following process: A. forming multiple sections of a web of entangled polymeric fibers, the polymeric fibers including from 55-80% by weight of at least one staple fiber and from 20-45% by weight of at least one binder fiber, wherein the average fiber diameter is from 12.0 to 20.5 microns and at least 55% by weight of the fibers are crimped, the web of entangled polymeric fibers having a weight of about 5 to 60 g/m²; B. forming a stack of said multiple web sections; and C. calibrating and heat-setting said stack of web sections to form an insulation batt containing multiple individual plies of entangled and heat-bonded polymeric fibers, each individual ply having a thickness of from 0.36 to 10.0 mm, wherein the insulation batt 1) has an uncompressed bulk density of from 6 to 14 kg/m³, 2) exhibits a lambda value of from 35-50 mW/m-K, 3) exhibits a lambda*density value of from 250-550 when lambda is expressed in units of mW/m-K and density is expressed in units of kg/m³ and 4) has an uncompressed thickness of from 25-300 mm. A mechanical carding or garnetting processes is used, it is preferred to produce the batt can be produced by forming a number of plies which are stacked together before being calibrated and heat set as a unit. Layering can be done longitudinally, or by crosslayering (sometimes referred to as cross lapping). As used for the lab-laminated examples, the thickness of the batt is about 140 mm and the surface area is approximately a square of from about 120 mm by 120 mm to about 300 mm by 300 mm.

A Chemsultants Mini-Laminator is employed for laminating a facer layer made of films listed in Table 1 (below), with the batt. The laminator includes a bottom driven rubber roll and a top hot idler roll of about 100 mm in diameter. The gap is adjusted to either about 6.35 mm or about 12.7 mm to allow the batt to be pulled through the roll by the driver roll. The batt surface is covered with a layer of fluoroglass film to keep the sample from sticking to the chrome hot roll. The roll speed is set at about 3.0 m/min with a contact distance of about 5.0 cm to give a dwell time of about 1 sec.

The temperature of the equipment is set to give the desired lamination temperature as the batt is drawn through either an about 6.35 mm or about 12.7 mm nip. The lamination temperature at the surface of the batt is determined using a temperature sensitive tape from Paper Thermometer Company, Inc. Lamination temperatures are varied from about 165° C. to about 71° C. and at about 1.5 to about 4.5 m/min line speed with the results as indicated below. The lamination temperature is measured using a TL-8-100, TL-8-210, TL-8-250 and TL-8-290 temperature sensitive tape applied to the batt to be at the interface of the batt surface and the adhesive film.

TABLE I
Description of multi-layer facer/adhesive films: - composition, layer thickness, other

| | | | | | | | | Lowest |
|---|---|---|---|---|---|---|---|---|
| | | | | | | | | Effective |
| | | | | | | | | Hot Roll |
| | | Bond | Adhesive | Adhesive Layer | Film | Melting Temp** (C.) | | Lamination |
| Film | Facer layer | Interface Layer | Layer (A) | Melt flow index | Thickness | Adhesive | Backing | Temper- |
| Name | composition | composition | Thickness % | (calculated)# | (mil/microns) | (A) | (C) | ature* ° C. |
| Film A | LDPE/HDPE/ | EAA(75%)/PE(20%)/ | 25 | 28.4 | 1.0/25 | 90 | 119 | 71 |
| | ULDPE Blend | Filler(5%) | | | | | | |
| Film B | PP (78 wt % | EAA(97%)/Filler(3%) | 20 | 2.8 | 2.0/51 | 95 | 155 | 82 |
| | of layer) | | | | | | | |
| Film C | LLDPE | EVA(95%)/Filler(5%) | 15 | 3.9 | 1.0/25 | 85 | 122 | 88 |
| Film D | HDPE | EMA(60%)/EAA(3%)/ | 15 | 3.4 | 2.0/51 | 84 | 127 | 88 |
| | | PE(32%)/Filler(5%) | | | | | | |
| Film E | LLDPE | None | NA | 1.0 | 1.5/38 | 121 | 121 | >110 |
| | | | | | | | | <160 |
| Film F | None | EAA(94%)/Filler(6%) | 100 | 5.3 | 2.0/51 | 101 | 101 | |
| Film G | HDPE | EMA(60%)/EAA(40%) | 15 | 20 | 2.0/51 | 71 | 127 | 71 |

*From Table V below
**Weighted average calculations of Tₘ for each component as obtained from a DSC of the film at about 10° C. per minute
#Calculated according to ASTM D1238 as MI (blend) = (W1*MI1\hat{ } −0.283 + W2*MI2\hat{ } −0.283 etc . . . )\hat{ } −3.53 where Wi and MIi are the weight fraction and the melt index of the i^{th} component.

Untreated films and corona treated films are employed as described and are identified as treated or untreated. Unless otherwise specified, the films are untreated. Treated films generally have a level of surface treatment for providing a surface energy ranging from about 38 to about 60 dyne/cm, and more preferably from about 40 to about 54 dyne/cm. Untreated films generally have a surface energy less than about 38 dyne/cm.

Batts as described above, are laminated by themselves (without the additional bonding interface layer) to help define the conditions that might cause a skin to form on the surface of the fibrous batt.

The quality of the skin is determined in two ways: First, if a skin is visible to the naked eye and second by attempting to write on the batt surface after putting the batt through the lamination process in the absence of an adhesive film. The difficulty in writing a sample number on the batt surface is used to judge the presence of a skin. In some cases, a sample number could be written on the batt using a permanent marker pen (e.g. Sharpie® Fine Point Permanent Marker or similar). In cases where no skin is present, the number had to be imprinted by making individual dots.

Batt is laminated at 3 different gaps (25 mm, 12.5 mm and 6 mm) and three different temperatures (about room temperature, about 154° C. and about 165° C.). Batt height is measured before and after lamination using a simple ruler, with the accuracy of height measurement being about 0.5 cm. Temperature measurement at the batt surface during lamination is found by placing Paper Thermometer Company, Inc. heat measurement tape on the surface of the batt. After putting the batt, with or without facer, thorough the lamination process, the temperature is read from the tape by following the manufacturer's directions.

TABLE II
Expected Results of process conditions testing

| | Temperature | | Height Before | Height After | |
|---|---|---|---|---|---|
| | by heat tape | Roll Gap | Lamination | Lamination | Compaction |
| Sample | (° C.) | (mm) | (cm) | (cm) | (cm) |
| 1 | 23 | 25⁽¹⁾ | 11 | 11 | <0.5 |
| 2 | 23 | 12.5⁽²⁾ | 11 | 10.75 | <0.5 |
| 3 | 23 | 6 | 10.5 | 10.25 | <0.5 |
| 4 | 154 | 6 | 10.25 | 9 | 1.25 |
| 5 | 154 | 6 | 10.25 | 9 | 1.25 |
| 6 | 154 | 6 | 10.25 | 8.5 | 1.75 |
| 7 | 154 | 6 | 10.25 | 8.0 | 2.25 |
| 8 | 165 | 6 | 10.25 | 8.5 | 1.75 |
| 9 | 165 | 6 | 10.25 | 8 | 2.25 |
| 10 | 165 | 6 | 10.25 | 8 | 2.25 |
| 11 | 165 | 6 | 10.25 | 7 | 3.25 |

⁽¹⁾At about the 25 mm roll gap, it is possible that the roll may not readily turn due to insufficient friction. Roll gap too high for the lab hot roll.
⁽²⁾At about the 12.5 mm roll gap, it is possible that the roll may turn slightly, with some slippage observed.
⁽³⁾At about the 6 mm roll gap, it is expected that the roll should turn well.

After putting the batt through the lamination process at about 23° C., no compaction of the batt is observed at roll gaps of 25 mm, 12.5 mm and 6 mm. After putting the batt through the lamination process at about 154° C. and about 165° C., compaction of the batt occurs and a batt skin is observed.

### Example 2

### Polyester Fiber Batt Facer Tests

In this Example, the insulation layer is analyzed for determining processing temperatures for avoiding skin formation in the insulation layer during lamination. An about 140 mm thick layer of batt is passed through the laminator at about 6 mm and about 12.5 mm roll gap, in the absence of any facer layer. Temperature is adjusted for identifying the temperature at which no formation of a batt skin is observed. Temperature is measured by using heat tapes placed on surface of the batt, Peel Strength analysis may be performed by a suitable method to measure heat seal strength, (e.g., ASTM F88) with draw rate of about 25.4 cm/min, a 22.7 kg load cell, and about 17.8 cm jaw gap. The samples are peeled back about halfway before inserting in the jaws of an INSTRON™ Tensile tester.

### Expected Results:

TABLE III
Results of testing for conditions that form skins on the fiber batt

| | | Hot Roll | | Lamina- | | |
|---|---|---|---|---|---|---|
| | | Surface Temp | | tion | | |
| | Hot Oil | by | Line | Temp by | Roll | |
| Sam- | Temp | Contact Probe | Speed | Heat Tape | Gap | Skin |
| ple | (° C.) | (° C.) | (m/min) | (° C.) | (mm) | Formed? |
| 12 | 143 | | 3 | 154 | 6 | Yes |
| 13 | 121 | 127 | 3 | 121 | 6 | Yes |
| 14 | 121 | 127 | 3 | 115 | 12 | Some |
| 15 | 121 | 127 | 4.5 | 115 | 12 | Slight |
| 16 | 121 | 127 | 4.5 | 104 | 6 | Yes |
| 17 | 104 | 107 | 4.5 | <104 | 6 | Slight |
| 18 | 104 | 107 | 3 | 99 | 6 | No |
| 19 | 104 | 107 | 3 | 99 | 12 | No |

At a lamination temperature of about 99° C. and about a 6 mm gap, skin formation is generally not expected. As can be seen from Table III, to help avoid formation of a skin the temperature, by heat tape, is lower than about 115° C., more preferably below about 104° C. and still more preferably below about 99° C.

These values are believed to be dependent on the melting temperature of the bonding layer of the bicomponent fiber, which in this case is about 110° C., and the dwell time in the heated zone that affects the ability to transfer heat to the fibers of the batt. The skin formation temperature is determined in the same manner for when bonding fibers of different melting temperatures are used. Because of the process to make the batts, the lowest melting bicomponent fiber is typically chosen both to reduce energy costs and to maximize the temperature difference between the melting points of the staple fiber and the bicomponent fiber.

### Example 3

In this Example, film adhesion is analyzed relative to expected skin formation temperature to help determine the lower limit peel adhesion temperature of the following facers: Film A untreated, Film D untreated, Film C untreated, Film E treated, Film G untreated. An about 140 mm thickness batt is laminated with test films at about 6 mm roll gap. Temperature is varied to determine when adhesion diminishes. Lamination temperature is measured using heat tapes placed on surface of batt between batt and facer.

TABLE IV
Samples Made for Peel Testing

| | Film A | Film C | Film B | Film D | Film E | Film G |
|---|---|---|---|---|---|---|
| Temperature | Sample | Sample | Sample | Sample | Sample | Sample |
| (° C.) | No | No | No | No | No | No |
| 104 | 20 | 21 | 22 | 23 | 24 | 48 |
| 99 | 25 | | | | | |
| 93 | | 26 | 27 | | | 47 |
| 88 | 28 | 29 | | 30 | 42 | 46 |
| 82 | 31 | 32 | 33 | | | 45 |
| 77 | 34 | 35 | 36 | 37 | | 44 |
| 71 | 38 | 39 | 40 | 41 | | 43 |

TABLE V
Expected Results of Peel Adhesion Data and Appearance

| | | | Peel Strength | | | Film |
|---|---|---|---|---|---|---|
| Sample | Temp | | Max | Avg | Surface | thickness |
| No | (° C.) | Film | N/mm | N/mm | Wrinkles | (micron) |
| Control | | Control | 0.023 | 0.016 | ----- | 1---- |
| | | no film | | | | |
| 20 | 104 | Film A | 0.055 | 0.035 | Coarse | 25 |
| | | | | | wrinkle | |
| 21 | 104 | Film C | 0.033 | 0.021 | Fine | 25 |
| | | | | | wrinkle | |
| 22 | 104 | Film B | 0.028 | 0.021 | smooth | 50 |
| 23 | 104 | Film D | 0.026 | 0.017 | Coarse | 25 |
| | | | | | wrinkle | |
| 24 | 104 | Film E | 0.012 | 0.002 | Deep | 38 |
| | | | | | wrinkle | |
| 25 | 99 | Film A | 0.033 | 0.023 | Coarse | 25 |
| | | | | | wrinkle | |
| 26 | 93 | Film C | 0.026 | 0.019 | Fine | 25 |
| | | | | | wrinkle | |
| 27 | 93 | Film B | 0.031 | 0.023 | smooth | 50 |
| 28 | 88 | Film A | 0.026 | 0.019 | Coarse | 25 |
| | | | | | wrinkle | |
| 29 | 88 | Film C | 0.028 | 0.019 | Wrinkle | 25 |
| 30 | 88 | Film D | 0.019 | 0.014 | inter- | 50 |
| | | | | | mediate | |
| 31 | 82 | Film A | 0.040 | 0.033 | Coarse | 25 |
| | | | | | wrinkle | |
| 32 | 82 | Film C | 0.014 | 0.005 | Wrinkle | 25 |
| 33 | 82 | Film B | 0.036 | 0.026 | smooth | 50 |
| 34 | 77 | Film A | 0.040 | 0.028 | Coarse | 25 |
| | | | | | wrinkle | |
| 35 | 77 | Film C | 0.012 | 0.003 | Coarse | 25 |
| | | | | | wrinkle | |
| 36 | 77 | Film B | 0.012 | 0.003 | smooth | 50 |
| 37 | 77 | Film D | 0.017 | 0.009 | smooth | 50 |
| 38 | 71 | Film A | 0.028 | 0.021 | Coarse | 25 |
| | | | | | wrinkle | |
| 39 | 71 | Film C | 0.012 | 0.002 | Coarse | 25 |
| | | | | | wrinkle | |
| Control | | Control | 0.023 | 0.016 | ----- | 1---- |
| | | no film | | | | |
| 40 | 71 | Film B | 0.014 | 0.005 | smooth | 50 |
| 41 | 71 | Film D | 0.014 | 0.005 | smooth | 50 |
| 42 | 88 | Film E | 0.000 | 0.000 | -- | 38 |
| B | NA | Fiberglass | 0.014 | 0.005 | -- | -- |
| R | NA | Fiberglass | 0.014 | 0.005 | -- | -- |
| 43 | 71 | Film G | 0.028 | 0.019 | Coarse | 51 |
| | | | | | wrinkle | |
| 44 | 77 | Film G | 0.033 | 0.024 | Coarse | 51 |
| | | | | | wrinkle | |
| 45 | 82 | Film G | 0.029 | 0.019 | Coarse | 51 |
| | | | | | wrinkle | |
| 46 | 88 | Film G | 0.033 | 0.023 | Coarse | 51 |
| | | | | | wrinkle | |
| 47 | 93 | Film G | 0.028 | 0.019 | Coarse | 51 |
| | | | | | wrinkle | |
| 48 | 104 | Film G | 0.028 | 0.019 | Coarse | 51 |
| | | | | | wrinkle | |

All laminations of Film B appear smooth at all temperature ranges. At about 104° C., Film D appears to have a wrinkled surface and at about 77° C. it stops wrinkling and takes on a smooth surface much like Film B. Films A and C form wrinkles at all temperature ranges.

The minimum adhesion temperature (approximate values) by film to match the No Facer Control peel results are as follows: Film A and Film G with an adhesion temperature of about 71° C.; Film B with an adhesion temperature of about 82° C.; Film C with a adhesion temperature of about 88° C.; Film D with a adhesion temperature of about 88° C.; Film E with a adhesion temperature that falls within the range of greater than about 110° C. and less than about 160° C.

The rank of appearance, based upon the amount of wrinkling of the film, is as follows: Film B; Film D; then the rest of the Film Types.

### Hot Air Lamination:

A hot air lamination machine as described in FIG. 2 is used to conduct the hot air lamination experiments. The machine includes four identical stations that can each be controlled independently. All four stations are linked in series with a single conveyor belt feeding the material through the laminators. Station 1 is at the inlet to the machine and Station 4 is at the outlet. For this experiment, Stations 1 and 2 are lifted as high as possible, no air is introduced, and the driven rollers are off. The air is heated by electric heaters whose set point is used to independently control the temperature of the process at each of the driven rolls. The temperature set point of the air introduced at Station 3 and Station 4 and the height of the driven roller are varied.

The line speed is set to about 6 m/min for the entire experiment. The setup of Stations 1 and 2 are identical to Station 3. The relative locations of Stations 1 and 2 are shown in FIG. 2.

The fiber batt is attached to a rigid insulation board in order to feed the material through the machine. The driven roller on Station 3 is as high as possible for all 7 trials. Only the height of the driven roller on Station 4 is adjusted. The film used for this experiment is Film B Clear at about 50 micron. The film is taped to the surface of the batt in Trial 1 prior to feeding into the laminator. The same application is taken on Trial 2, but the batt detached from the rigid board and wrapped around the driven roller on Station 4. For trials 3 through 7, the film is introduced from above the driven roller on Station 4, as indicated in FIG. 2, and drawn through the laminator by the batt and driven roller. After the skin formation is detected on Trial 4, the heat on Station 3 is turned off. Only the first about 2.4 m of the approximately 10 m roll is taped to the rigid board during Trial 6. The remaining approximately 7.6 m of material is allowed to lie directly on the bottom conveyor belt.

A preferred hot-air lamination method requires only one station as described above wherein the temperature set point for the electrically heated hot air is adjusted to give adhesion of the facer to the batt without wrinkling or causing skin formation. In this case, it is preferred to have the temperature of Station 4 at about 221° C., more preferably about 227° C.

TABLE VI

| | | | | | | | | Height of |
|---|---|---|---|---|---|---|---|---|
| | Batt | Batt | Film | | | Station | Station | Compressed |
| | Width | Length | width | Wrinkle | Skin | 3 Temp | 4 Temp | Batt |
| Trial | (cm) | (m) | (cm) | Formation | Formation | (° C.) | (° C.) | (mm) |
| 49 | 38 | 2.4 | 35 | no | no | 149 | 204 | 38 |
| 50⁺ | 38 | 2.4 | 35 | NA | NA | 160 | 216 | NA |
| 51 | 38 | 2.4 | 35 | no | no | 160 | 216 | 38 |
| 52 | 38 | 2.4 | 35 | no | yes | 171 | 227 | 38 |
| 53 | 38 | 2.4 | 35 | no | no | Off | 227 | 38 |
| 54 | 61 | 10 | 61 | no | no | Off | 227 | Varied* |
| 55 | 38 | 2.4 | 61 | yes | no | Off | 227 | 13 |

*Batt height on Trial 54 is about 38 mm for the first approximately 2.4 m that is taped to the rigid board and about 51 mm for the remaining approximately 7.6 m.
⁺It is possible that a trial may fail due to film becoming wrapped around roll.

The conditions that produce attractive material are Station 3 off, Station 4 at about 227° C. and the batt compressed to about 38 cm (Trials 53 & 54). It is believed that, in this piece of equipment, excessive compression can lead to wrinkles (Trial 55). In Trials 49 and 51, adhesion is satisfactory. However, the adhesion observed by hand pulling of the film from the batt for Trials 53 and 54 is expected to be slightly better.

### Flat Bed Lamination:

An Astex 3024-HP fusing system manufactured by Astechnologies is used. This lab laminator is configured with two heating zones, one for the top surface and one for the bottom surface. The temperature of the top zone is varied and the bottom zone is set to about 25° C. The heating zone of the laminator is about 56 cm in the machine direction and about 61 cm wide. The air pressure on the pinch roll system at the end of the heating zone is set to about 0 N/mm². All of the fiber batt samples used for this experiment are cut to about 20×30 cm. For all of the samples, the film is cut to approximately the same size as the batt, placed on the top surface of the batt and the sample is covered with a cover sheet material made by Taconic. This material is made from polytetrafluoroethylene (PTFE) resin and is woven with glass strands (Taconic 7069). A temperature strip is placed between the fiber ball and the film to monitor the temperature at the batt surface during the lamination,

TABLE VII

| | | Belt | Dwell Time | Heater | Batt | Thickness | | | |
|---|---|---|---|---|---|---|---|---|---|
| | | Speed | in Heated Zone | Set point | Surface Temp | Loss | Film | Film | Skin |
| Sample | Film | (m/min) | (sec) | (° C.) | (° C.) | (cm) | Appearance | Adhesion | Formation |
| FB1 | None | 8 | 4.22 | 93 | 88 | 1.25 | NA | NA | None |
| FB13 | None | 11 | 2.95 | 104 | 88 | 0.75 | NA | NA | Slight |
| FB17 | Film B | 13 | 2.75 | 93 | 77 | 0.5 | Good | None | None |
| FB2 | Film B | 8 | 4.22 | 93 | 82 | 0.5 | Fair | Poor | None |
| FB9 | Film B | 12 | 2.75 | 104 | 82 | ? | Fair | Poor | None |
| FB6 | Film B | 10 | 3.44 | 104 | 88 | 1.25 | Fair | Excellent | None |
| FB3 | Film B | 8 | 4.22 | 104 | 90 | 1.0 | Fair | Excellent | None |
| FB5 | Film B | 10 | 3.44 | 110 | 96 | 1.25 | Fair | Excellent | None |
| FB4 | Film B | 6 | 5.24 | 104 | 102 | 1.0 | Fair | Excellent | None |
| FB7 | Film B | 5 | 6.87 | 104 | 107 | 1.75 | Fair | Excellent | Slight |
| FB8 | Film B | 2.5 | 13.75 | 104 | 127 | 6.0 | Fair | Excellent | High |
| FB10 | Film C | 12 | 2.75 | 104 | 85 | 0.5 | Fair | Poor | None |
| FB11 | Film C | 10 | 3.44 | 104 | 88 | 1.0 | Fair | Good | None |
| FB12 | Film C | 6 | 5.24 | 104 | 93 | 2.5 | Fair | Good | None |
| FB16 | Film D | 12 | 2.75 | 93 | 77 | 0.75 | Fair | Poor | None |
| FB14 | Film D | 12 | 2.75 | 104 | 85 | 0.75 | Fair | Poor/Good | None |
| FB15 | Film D | 6 | 5.24 | 104 | 99 | 1.9 | Fair | Poor/Good | None |

These experiments show that this type of lamination equipment can be successfully used. As noted in the above table the fastest belt speeds generally show the lowest thickness loss. The greatest thickness loss is expected for samples FB7 and FB8, especially when compared to FB17, at the slowest belt speeds and longest dwell time. The appearance of an undesirable skin beneath the facer composed of compressed and bonded fibers is also possible for FB7 and FB8. Though other lamination temperatures are possible, it is believed that an attractive lamination temperature for Film B is between about 85° C. and about 105° C.

### Second Flat Bed Laminator

A Glenro Integrated Energy Delivery System laminator is used. This lab laminator is configured with two heating zones, one for the top surface and one for the bottom surface. The temperature of the top zone is set to about 100° C. and the bottom zone is set to about 25° C. Because of the close proximity of the two belts, the temperature indicator on the bottom belt indicated about 79° C. when the material is introduced. The fiber batt is brought into the heating zone at a speed of about 12.6 m/min (machine setting of 10). The heating zone of the laminator is about 1.00 m long in the machine direction and about 1.02 m wide (i.e. resulting in a dwell time of about 4.37 sec). The air pressure on the pinch roll system at the end of the heating zone is set to about 0.124 N/mm² for the samples and the first full batt and increased to about 0.55 N/mm² for the second full batt. A temperature strip is placed between the fiber batt and the film to monitor the temperature at the batt surface during the lamination. The fiber batt and film is protected using a bottom and top cover sheet material made by Taconic. This material is made from polytetrafluoroethylene (PTFE) resin and is woven with glass strands (Taconic 7069). This cover sheet covered the entire sample for the small batts. The cover sheet only covered approximately the first 0.6 m of the approximately 2.4 m long batts. The film used for this experiment is Film B Clear of about 51.0 micron thick.

TABLE VIII

| | Batt | Batt | Film | | | | Heater | Batt | Pinch Roll |
|---|---|---|---|---|---|---|---|---|---|
| | Width | Length | width | | Film | Skin | Set point | Surface Temp | Pressure |
| Trial | (cm) | (m) | (cm) | Adhesion | Appearance | Formation | (° C.) | (° C.) | (N/mm²) |
| FB16 | 30.5 | 0.2 | 30.5 | Good | Fair | None | 100 | 79 | 0.124 |
| | | | | | | | | covered | |
| FB17 | 38 | 2.4 | 38 | Good | Fair | None | 100 | 77 | 0.124 |
| | | | | | | | | covered, | |
| | | | | | | | | 82 | |
| | | | | | | | | uncovered | |
| FB18 | 38 | 2.4 | 38 | Excellent | Fair | None | 100 | 85 | 0.55 |
| | | | | | | | | uncovered | |

This type of equipment may also be used for laminating a facer to a polyester fiber batt. It is preferred, for this equipment, the batt surface temperature is about 82° C. and more preferably about 85° C. as measured. The adhesion improved significantly when the roll pressure is increased from about 0.124 to about 0.55 N/mm².

### Fire Performance Testing:

Film B, clear film is laminated as a facer to polyester fiber batts as described above using a hot roll lamination process. The lamination produces a product without skin formation and with a wrinkle free facer. Faced batts are produced with about 50 micron thick facers. These products are tested per ASTM E-84: Standard Test Method for Surface Burning Characteristics of Building Materials with both un-slit and slit facers. (All testing is conducted at South West Research Institute (SWRI) in San Antonio, Tex.) The ASTM E84 results for the un-slit faced batt are expected to be a Flame Spread Index (FSI) of about 15 and a Smoke Developed Index (SDI) of about 410. The ASTM E84 results for the slit-faced batt are expected to be a FSI of about 5 and a SDI of about 375.

When testing per ASTM E84, the FSI and SDI are expected to decrease (improve) with a decrease in fuel source. For example, the FSI & SDI for about a 25 micron thick facer laminated to a polyester fiber batt are less than the FSI & SDI for about a 100 micron thick facer of the same composition and density laminated to the same polyester fiber batt.

In addition to ASTM E84 testing, the polyester fiber batts faced (un-slit) with about a 50 micron Film B, clear film via hot roll lamination are also tested at SWRI per ASTM E970: Standard Test Method for Critical Radiant Flux of Exposed Attic Floor Insulation Using a Radiant Heat Energy Source. The tested sample has a critical radiant heat flux of about 1.09 W/cm². As with ASTM E-84, an improvement in test results of the ASTM E970 test is also expected as the amount of available fuel is decreased. Thus, the heat flux for a batt with an about 25 micron thick facer is less than the heat flux for a batt with an about 100 micron thick facer when both facers are laminated to a batt of the same composition and density.

TABLE IX
General Material Properties of Films

| Physical | | | Imperial Values | | | |
|---|---|---|---|---|---|---|
| Properties | | Test Method | at 2.0 mil¹ | | Metric Values | |
| Film A | | | | | | |
| Ultimate Tensile | MD | ASTM D 882 | 3185 | psi | 22 | N/mm² |
| | TD | | 2025 | psi | 14 | N/mm² |
| Ultimate | MD | ASTM D 882 | 220% | | 220% | |
| Elongation | TD | | 425% | | 425% | |
| Tensile Modulus, | MD | ASTM D 882 | 32,245 | psi | 222 | N/mm² |
| 2% Secant | TD | | 41,115 | psi | 284 | N/mm² |
| Elmendorf Tear | MD | ASTM D 1922 | 14 | g/mil | 1 | g/μm |
| | TD | | 446 | g/mil | 18 | g/μm |
| Film B | | | | | | |
| Ultimate Tensile | MD | ASTM D 882 | 4400 | psi | 30 | N/mm² |
| | TD | | 3100 | psi | 21 | N/mm² |
| Tensile Modulus, | MD | ASTM D 882 | 40,000 | psi | 270 | N/mm² |
| 2% Secant | TD | | 40,000 | psi | 270 | N/mm² |
| Ultimate | MD | ASTM D 882 | 460% | | 460% | |
| Elongation | TD | | 560% | | 560% | |
| Elmendorf Tear | MD | ASTM D 1922 | 100 | g/mil | 5 | g/μm |
| | TD | | 500 | g/mil | 20 | g/μm |
| Film C | | | | | | |
| Ultimate Tensile | MD | ASTM D 882 | 3600 | psi | 25 | N/mm² |
| | TD | | 3900 | psi | 27 | N/mm² |
| Ultimate | MD | ASTM D 882 | 425% | | 425% | |
| Elongation | TD | | 700% | | 700% | |
| Tensile Modulus, | MD | ASTM D 882 | 27,000 | psi | 186 | N/mm² |
| 2% Secant | TD | | 33,000 | psi | 227 | N/mm² |
| Elmendorf Tear | MD | ASTM D 1922 | 125 | g/mil | 5 | g/μm |
| | TD | | 600 | g/mil | 24 | g/μm |
| Film D | | | | | | |
| Ultimate Tensile | MD | ASTM D 882 | 2710 | psi | 19 | N/mm² |
| | TD | | n/a | | n/a | |
| Ultimate | MD | ASTM D 882 | 330% | | 330% | |
| Elongation | TD | | n/a | | n/a | |
| Tensile Modulus, | MD | ASTM D 882 | 39,180 | psi | 290 | N/mm² |
| 2% Secant | TD | | 42,130 | psi | 227 | N/mm² |
| Elmendorf Tear | MD | ASTM D 1922 | 130 | g/mil | 5 | g/μm |
| | TD | | 300 | g/mil | 12 | g/μm |
| Film E | | | | | | |
| Yield Tensile | MD | ASTM D 882 | 1700 | psi | 12 | N/mm² |
| | TD | | 1600 | psi | 11 | N/mm² |
| Ultimate Tensile | MD | ASTM D 882 | 4000 | psi | 28 | N/mm² |
| | TD | | 3000 | psi | 21 | N/mm² |
| Tensile Modulus, | MD | ASTM D 882 | 27,000 | psi | 190 | N/mm² |
| 2% Secant | TD | | 31,000 | psi | 210 | N/mm² |
| Ultimate | MD | ASTM D 822 | 510% | | 510% | |
| Elongation | TD | | 570% | | 570% | |
| Gloss, 45° | | ASTM D 2457 | 60 | | 60 | |
| Elmendorf Tear | MD | ASTM D 1922 | 240 | g/mil | 10 | g/μm |
| | TD | | 670 | g/mil | 27 | g/μm |
| Film F | | | | | | |
| Ultimation Tensile | MD | ASTM D 882 | 3600 | psi | 25 | N/mm² |
| | TD | | 3300 | psi | 23 | N/mm² |
| Ultimate | MD | ASTM D 882 | 320% | | 320% | |
| Elongation | TD | | 490% | | 490% | |
| Tensile Modulus, | MD | ASTM D 882 | 20,000 | psi | 138 | N/mm² |
| 2% Secant | TD | | 19,000 | psi | 131 | N/mm² |

| | | | | |
|---|---|---|---|---|
| Film G | Not available | Not available | Not available | Not available |

1-30. (canceled)

31. A faced polymeric fiber insulation batt comprised of at least one facer layer and a fiber insulation layer, the facer layer being joined with the fiber insulation layer via at least one bond interface layer that includes at least one adhesive.

32. The faced polymeric fiber insulation batt of claim 31 wherein the facer layer includes at least one layer with a melting temperature, as measured by DSC, of greater than 125° C.

33. The faced polymeric fiber insulation batt of claim 31 wherein the facer layer includes at least one material chosen from the group consisting of polypropylene, high density polyethylene, blends of polypropylene with polyolefin, blends of high density polyethylene olefins, and any combination thereof.

34. The faced polymeric fiber insulation batt of claim 31 wherein the at least one adhesive is a single layer adhesive film located on at least one side of the facer layer.

35. The faced polymeric fiber insulation batt of claim 31 wherein the at least one adhesive includes one or more materials selected from the group consisting of anhydride modified polyethylene or anhydride modified copolymers of polyethylene, ethylene-acrylic acid, ethylene-vinyl acetate, ethylene methyl acrylate, ethylene-methacrylic acid polymer, blends of the former with low density polyethylene and linear low density polyethylene, and any combination thereof.

36. The faced polymeric fiber insulation batt of claim 31 wherein the thickness of the bond interface layer ranges from 1 to 25 microns, and further wherein the bond interface layer includes an adhesive with a melt flow index that ranges from 1 to 5.

37. The faced polymeric fiber insulation batt of claim 31 wherein the facer layer comprises at least a top layer and a bottom layer, wherein the top layer melting point is greater than 30° C. and a thickness of 15 to 200 microns.

38. The faced polymeric fiber insulation batt of claim 31 wherein the faced polymeric fiber insulation batt has a critical radiant heat flux, as determined by ASTM E-970, of equal to or greater than 0.12 W/cm².

39. The faced polymeric fiber insulation batt of claim 31 wherein the faced fiber insulation batt has a density greater than 5 kg/m³.

40. The faced polymeric fiber insulation batt of claims 31 wherein the faced fiber insulation batt has a lambda value less than 50 mW/m-K.

41. The faced polymeric fiber insulation batt of claim 31, wherein the fiber insulation layer includes a plurality of polymeric fibers with an average diameter from 3 to 50 microns, and a fiber melting temperature above 70° C.

42. The faced polymeric fiber insulation batt of claim 31, wherein the fiber insulation layer includes at least 55% by weight of a staple fiber and at least 15% by weight of a bicomponenet fiber.

43. The faced polymeric fiber insulation batt of claim 31 wherein at least one surface of the facer layer has a surface energy above 40 dyne/cm.

44. The faced polymeric fiber insulation batt of claim 31 wherein the at least one adhesive of the bond interface layer has a melting temperature at least 5° C. above the fiber batt polymeric fiber melting temperature.

45. The faced polymeric fiber insulation batt of claim 31 wherein the at least one adhesive exhibits a melt flow index of greater than 1.5.

46. A faced polymeric fiber insulation batt of claim 31 wherein the facer layer includes a single layered film of a material selected from the group consisting of Polypropylene, High Density Polyethylene, blends of Polypropylene with Polyolefin, blends of High Density Polyethylene olefins, and any combination thereof.

47. A method for producing a faced polymeric fiber insulation batt, comprising:
A. feeding a polymeric fiber batt having a first thickness onto a moving conveyor;
B. applying heat to the fiber batt and to a facer film;
C. joining the facer film to at least the top side of the fiber batt while applying a compressive load to the batt and the facer film sufficient to realize a compressive ratio of the fiber batt from the first thickness to a final thickness that ranges from 25:1 to 2:1;
D. conveying the facer film and fiber batt to a cooling area;
E. cooling the facer film and the fiber bat and
F. cutting the faced fiber batt to a pre-set length.

48. The method of claim 47 wherein the temperature during the applying heat step (B) is at least 60° C.

49. The method of claim 47 wherein the velocity of the moving conveyor is at least 1 m/min.

50. The method of claim 47 wherein the compressive load is applied over a contact length of at least 3 cm.

51. The method of claim 47 wherein the step of cutting is performed by a barrel rotary cutter that spins along an axis generally perpendicular to the direction of motion of the conveyor, and wherein the barrel rotary cutter includes at least one set of cutting blades disposed generally perpendicular to and in a direction away from the surface of an external surface of the barrel rotary cutter.

52. The method of claim 47 wherein the step of heating includes applying heat by convection of heated air.

53. The method of claim 52, wherein the temperature of the heated air is at least 150° C.

54. The method of claim 47 wherein the step of heating is done by conduction via contact with at least one heated surface zone.

55. The method of claim 54 wherein the temperature of the at least one heated surface zone is at least 80° C.

56. The method of claim 54 wherein the at least one heated zone is at least 25 mm in length, and spans in a direction generally parallel to conveyor.

57. The method of claim 47 wherein an adhesive is applied to form a bond interface layer between the facer film and the fiber batt.
